(19) United States
(12) Patent Application Publication
(10) Pub. No.: US 2004/0139299 A1
(43) Pub. Date: Jul. 15, 2004

(54) Operand forwarding in a superscalar processor

(75) Inventors: Fadi Busaba, Poughkeepsie, NY (US); Klaus J. Getzlaff, Schoenaich (DE); Bruce C. Giamei, Poughkeepsie, NY (US); Christopher A. Krygowski, Lagrangeville, NY (US); Timothy J. Slegel, Staatsburg, NY (US)

Correspondence Address: Lynn L. Augspurger, IBM Corporation, 2455 South Road, P386, Poughkeepsie, NY, 12601, US

(73) Assignee: International Business Machines Corporation, Armonk, NY

(21) Appl. No.: 10/341,900

(22) Filed: Jan. 14, 2003

(51) Int. Cl. G06F 9/30

(52) U.S. Cl. 712/218

(57) ABSTRACT

A method and mechanism for improving Instruction Level Parallelism (ILP) of a program and eventually improving Instructions per cycle (IPC) allows dependent instructions to be grouped and dispatched simultaneously by forwarding the oldest instruction, or source instruction, General Register (GR) data to the other dependent instructions. A source instruction of a load type loading a GR value into a GR. The dependent instructions will then select the forwarded data to perform their computation. The dependent instructions use the same GR read address as the source instruction. Another source instruction of a load type loads a memory data into a GR. The loaded memory data is forwarded or replicated on the memory read bus of the other dependent instructions. The mechanism allows Address Generator Output to be forwarded to the other dependent instructions when the source instruction is a load type loading a memory address into a GR. Then the loaded address is forwarded or replicated on the address bus of the other dependent instructions. Then, also, Control Register (CR) data is forwarded to the other dependent instructions when the source instruction is a load type loading a CR value into a General Register. Then the loaded CR data is forwarded or replicated on the CR data bus of other dependent instructions. When the source instruction is a load type loading an immediate value into a General Register, loaded immediate data is forwarded or replicated on the immediate data bus of other dependent instructions.

### FIELD OF THE INVENTION

This invention is related to computers and computer systems and to the instruction-level parallelism and in particular to dependent instructions that can be grouped and issued together through a superscalar processor.

Trademarks: IBM® is a registered trademark of International Business Machines Corporation, Armonk, N.Y., U.S.A. Other names may be registered trademarks or product names of International Business Machines Corporation or other companies

### BACKGROUND

The efficiency and performance of a processor is measured in the number of instructions executed per cycle (IPC). In a superscalar processor, instructions of the same or different types are executed in parallel in multiple execution units. The decoder feeds an instruction queue from which the maximum allowable number of instructions are issued per cycle to the available execution units. This is called the grouping of the instructions. The average number of instructions in a group, called size, is dependent on the degree of instruction-level parallelism (ILP) that exists in a program. Data dependencies among instructions usually limit ILP and result, in some cases, in a smaller instruction group size. If two instructions are dependent, they cannot be grouped together since the result of the first (oldest) instruction is needed before the second instruction can be executed resulting to serial execution. Depending on the pipeline depth and structure, data dependencies among instructions will not only reduce the group size but also may result in “gaps”, sometimes called “stalls” in the flow of instructions in the pipeline. Most processors have bypasses in their data flow to feed execution results immediately back to the operand input registers to reduce stalls. In the best case this allows a “back to back” execution without any cycle delays of data dependent instructions. Others support out of order execution of instructions, so that newer, independent instructions can be executed in these gaps. Out of order execution is a very costly solution in area, power consumption, etc., and one where the performance gain is limited by other effects, like misprediction branches and increase in cycle time.

### SUMMARY OF THE INVENTION

Our invention provides a method that allows the grouping and hence of dependent instructions in a superscalar processor. The dependent instruction(s) is not executed after the first instruction, it is rather executed together with it. The grouping when dependent instructions are dispatched together for execution is made possible due to the operand forwarding. The operand of the source instruction (architecturally older) is forwarded as it is being read to the target dependent instruction(s) (newer instruction(s)).

In accordance with the invention, ILP is improved in the presence of FXU dependencies by providing a mechanism for operand forwarding from one FXU pipe to the other.

In accordance with our invention, instruction grouping can flow through the FXU. Each of the groups 1 and 2 consists of three instructions issued to pipes B, X and Y. Group 3 consists only of two instructions with pipe Y being empty and this, as discussed earlier, may be due to instruction dependencies between groups 3 and 4. This gap empty slot may be filled by operand forwarding.

These and other improvements are set forth in the following detailed description. For a better understanding of the invention with advantages and features, refer to the description and to the drawings.

### DESCRIPTION OF THE DRAWINGS

FIG. 1 illustrates the pipeline sequence for a single instruction.

FIG. 2 illustrates the FXU Instruction Execution Pipeline Timing.

FIG. 3 illustrates an example of register forwarding.

FIG. 4 illustrates an example of storage forwarding.

FIG. 5 illustrates an example of Address/Immediate forwarding.

Our detailed description explains the preferred embodiments of our invention, together with advantages and features, by way of example with reference to the drawings.

### DETAILED DESCRIPTION OF THE INVENTION

In accordance with our invention we have provided an operand forwarding mechanism for the superscalar (multiple execution pipes) in-order micro-architecture of our preferred embodiment, as illustrated in the Figures.

Operand forwarding is used, when the first instruction and (or) oldest instruction, loads an operand into a register, and a subsequent instruction (as a target instruction), reads the same loaded register. The target instruction may set in parallel a condition code or perform other functions, related to the operand. The operand may originate from storage, GR-data or may be a result, like an address or an immediate operand, which has been generated in the pipeline earlier. Rather than waiting for the execution of the first instruction and writing the result back, the respective input data are routed directly also to the input registers of next instruction(s).

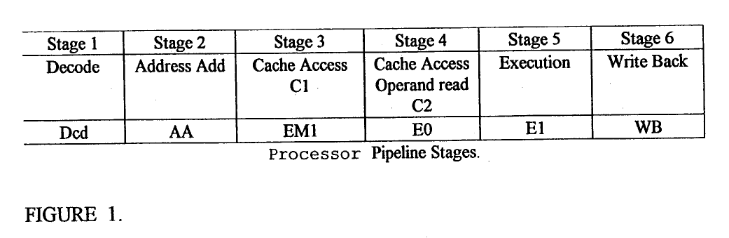

Operand forwarding is not limited to any processor micro-architecture and is we feel best suited for superscalar (multiple execution pipes) in-order micro-architecture. The following description is of a computer system pipeline where our operand forwarding mechanism and method is applied. The basic pipeline sequence for a single instruction is shown in FIG. 1A. The pipeline does not show the instruction fetch from Instruction Cache (I-Cache). The decode stage (DcD) is when the instruction is being decoded, and the B and X registers are being read to generate the memory address for the operand fetch. During the Address Add (AA) cycle, the displacement and contents of the B and X registers are added to form the memory address. It takes two cycles to access the Data cache (D-cache) and transfer the data back to the execution unit (C1 and C2 stages). Also, during C2 cycle, the register operands are read from the register file and stored in working registers preparing for execution. The E1 stage is the execution stage and WB stage is when the result is written back to register file or stored away in the D-cache. There are two parallel decode pipes allowing two instructions to be decoded in any given cycle. Decoded instructions are stored in instruction queues waiting to be grouped and issued. The instructions groupings are formed in the AA cycle and are issued during the EM1 cycle, which overlaps with the C1 cycle). There are four parallel execution units in the Fixed Point Unit named B, X, Y and Z. Pipe B is a control only pipe used for the branch instructions. The X and Y pipes are similar pipes capable of executing most of the logical and arithmetic instructions. Pipe Z is the multi-cycle pipe used mainly for decimal instructions and for integer multiply instructions. The IBM zSeries current micro-architecture allows the issue of up to three instructions; one branch instruction issued to B-pipe, and two Fixed Point Instructions issued to pipes X and Y. Multi-cycle instructions are issued alone. Data dependencies detection and data forwarding are needed for AA and E1 cycles. Dependencies for address generation in AA cycle are often referred to as Address-Generation Interlock (AGI), whereas dependencies in E1 stage is referred to as FXU dependencies.

The operand forwarding is limited to a certain group of instructions. For a given two instructions i and j of a group, an operand of instruction i is forwarded to the input registers of instruction j if instruction i is architecturally older than instruction j, instruction i is a load-type, instruction j is dependent on the result of instruction i, and the result of instruction i is easily extracted from the operand. Easily extracted means that no arithmetic or logical operation is required on the operand to calculate the result; the operand is either loaded as is or sign extended before being loaded. The source of instruction i operand can originate from local registers, storage, architected registers, output from the AA stage, or immediate field specified in the instruction. Although instruction i is only limited to load-type, these instructions are very frequent in many workloads and operand forwarding gives a significant IPC improvement with little extra hardware. In the following, some detailed examples are given.

The first example describes a register operand forwarding case. There are two instructions, the first or source instruction, LR, loads R1 from R2. The next or target instruction performs an arithmetic operation using R1 and R3 and writing the result back to R3.

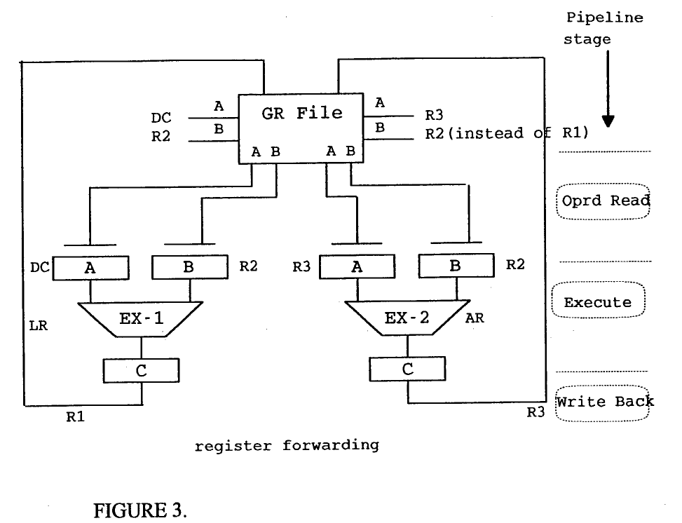

FIG. 3 shows how R2 is used as a GR read address of the target instruction instead of R1. The dependency is not limited to one operand and either or both operands of the target instruction may be dependent of the source target instruction.

Source Instruction LR R1, R2

Target Instruction AR R3, R1

The issue logic ignores the read after write conflict with R1, because the LR instruction can forward its operand. It groups both instructions together and modifies the register number for AR from R1 to R2. At the Register read stage of the pipe LR reads R2 and AR reads R2 (instead of R1) and R3. No extra data input bus is needed at the second execution unit, there is only an extra multiplexer level needed in the register address logic. This example also covers the case when the load instruction loads a register from the architected registers that are not shadowed locally in the FXU.

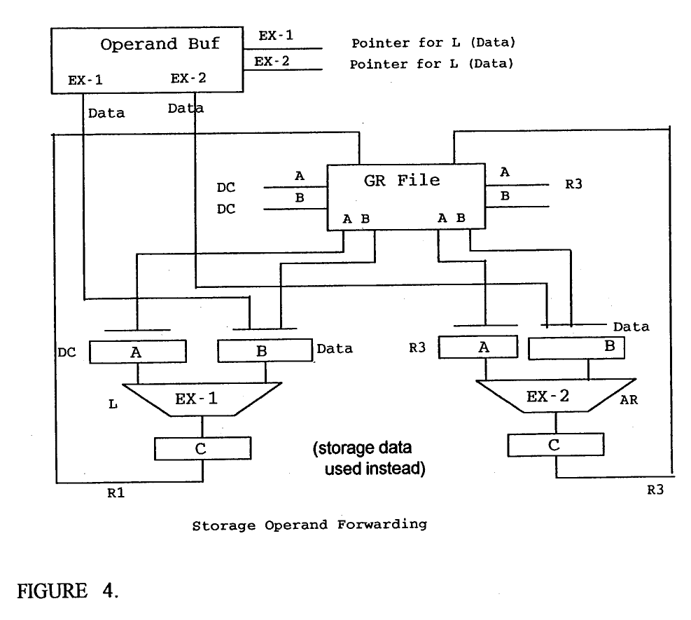

The second example describes a storage operand forwarding case; see FIG. 4. A load instruction loads R1 from storage. The next instruction performs an arithmetic operation, using R1, R3 and writing the result back to R3.

L R1, Storage

AR R3, R1

Again, the issue logic ignores the read after write conflict with R1, because the L instruction can forward its storage operand. It groups both instructions together and modifies the input selection for the second execution unit from register to the operand buffer (which contains the data for the L instruction). At the Register/operand buffer read stage of the pipe L reads the operand buffer and AR reads the operand buffer (instead of R1) and R3. No extra input bus is needed for the second execution unit, there is only an extra multiplexer level needed in the operand buffer address logic.

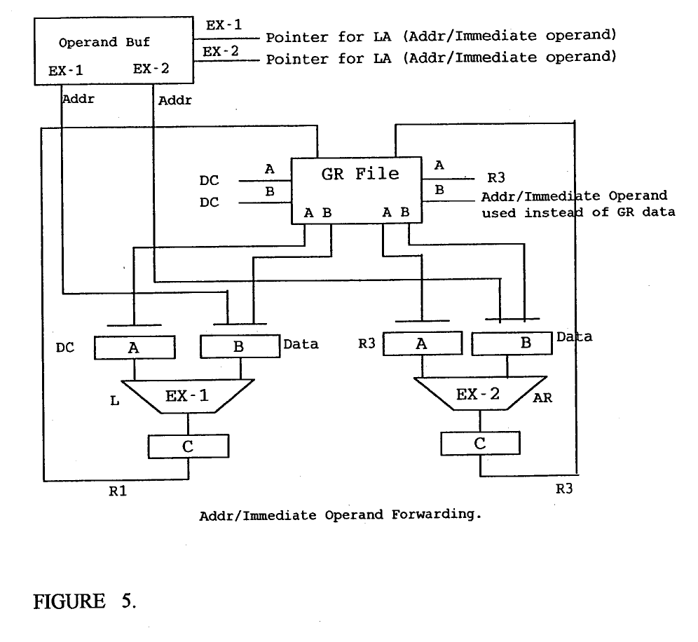

The third example describes an address/immediate operand forwarding case as shown in FIG. 5. A load address instruction loads R1 with the generated address from the address adder stage (Base register+Index register+Displacement). The next instruction performs an arithmetic operation, using R1, R3 and writing the result back to R3.

LA R1, Generated Address

AR R3, R1

Again, the issue logic ignores the read after write conflict with R1, because the LA instruction can forward its address operand. It groups both instructions together and modifies the input selection for the second execution unit from register to the immediate operand buffer, which contains the LA data. At the operand buffer read stage of the pipe LA reads the operand buffer and AR reads also the operand buffer (instead of R1) and R3. No extra input bus is needed for the second execution unit, there is only an extra multiplexer level needed in the operand buffer address logic. The example also covers the common case, where an immediate operand from the instruction is loaded into a register.

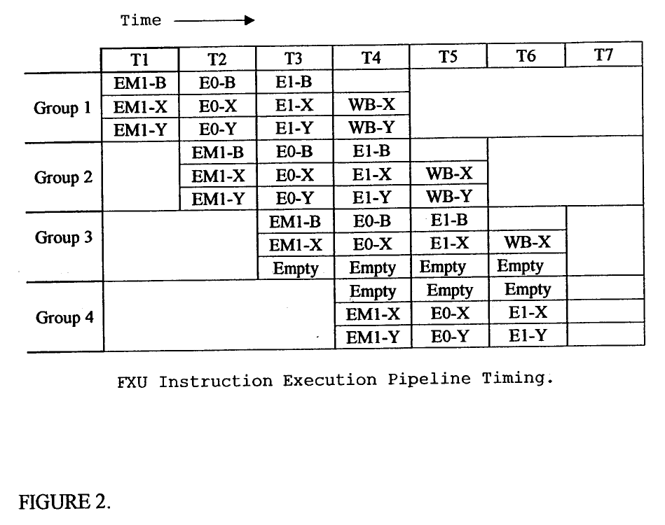

As has been stated, FIG. 2 illustrates the FXU Instruction Execution Pipeline Timing. With such timing ILP is improved in the presence of EXU dependencies by providing a mechanism for operand forwarding from one FXU pipe to the other.

Instruction grouping can flow through the FXU. Each of the groups 1 and 2 consists of three instructions issued to pipes B, X and Y. Group 3 consists only of two instructions with pipe Y being empty and this, as discussed earlier, may be due to instruction dependencies between groups 3 and 4. This gap empty slot may be filled by operand forwarding.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer system mechanism of improving Instruction Level Parallelism (ILP) of a program, comprising:
an operand forwarding mechanism for a superscalar (multiple execution pipes) in-order micro-architected computer system having multiple execution pipes and providing operand forwarding of an operand when a first and oldest source instruction loads an operand into a register, and a subsequent instruction reads the same loaded register, and rather than waiting for the execution of the first source instruction and writing the result back, the input data are routed directly to the input registers of subsequent instructions in said execution pipes.

2. The computer system mechanism according to claim 1 wherein said subsequent instruction is a target instruction and said target instruction sets in parallel a condition code or performs other functions related to the operand.

3. The computer system mechanism according to claim 1 wherein said operand being forwarded may originate from storage or from GR-data or may be a result, an address or an immediate operand, which has been generated in the pipeline earlier in the pipe.

4. The computer system mechanism according to claim 1 wherein said mechanism allows dependent instructions to be grouped and dispatched simultaneously by forwarding the first and oldest source instruction General Register (GR) data to other dependent instructions.

5. The computer system mechanism according to claim 4 wherein said first and oldest source instruction is a load type instruction loading a GR value into a general register (GR).

6. The computer system mechanism according to claim 4 wherein said dependent instructions will then select the forwarded data to perform their computation.

7. The computer system mechanism according to claim 5 wherein said dependent instructions will then use the same GR read address as the source instruction to perform their computation.

8. The computer system mechanism according to claim 1 wherein dependent instructions are grouped and dispatched simultaneously by forwarding the first and oldest source instruction and memory read data to the other dependent instructions.

9. The computer system mechanism according to claim 1 wherein said source instruction is a load type loading a memory data into a general register (GR) and said loaded memory data is forwarded or replicated on a memory read bus of other dependent instructions.

10. The computer system mechanism according to claim 1 wherein dependent instructions are grouped and dispatched simultaneously by forwarding Address Generator Output addresses to other dependent instructions and the loaded addresses are forwarded or replicated on the address bus of said other dependent instructions.

11. The computer system mechanism according to claim 1 wherein dependent instructions are grouped and dispatched simultaneously by forwarding Control Register (CR) data to other dependent instructions the source instruction.

12. The computer system mechanism according to claim 1 wherein said source instruction is a load type loading a Control Register (CR) value into a general register (GR) and said loaded CR data is forwarded or replicated on a memory read bus of other dependent instructions on a CR data bus of other dependent instructions.

13. The computer system mechanism according to claim 1 wherein dependent instructions are grouped and dispatched simultaneously by forwarding intermediate data to other dependent instructions the source instruction.

14. The computer system mechanism according to claim 1 wherein said source instruction is a load type loading an intermediate value into a general register (GR) and said intermediate value is forwarded or replicated on a memory read bus of other dependent instructions on a CR data bus of other dependent instructions.
